(19) United States
(12) Patent Application Publication
(10) Pub. No.: US 2025/0379732 A1
(43) Pub. Date: Dec. 11, 2025

(54) PROGRAMMABLE KEY PORTAL FOR SELECTIVELY CUSTOMIZABLE USER INTERACTION WITHIN A METAVERSE

(71) Applicant: CoCreateX Inc., Saint Paul, MN (US)

(72) Inventor: Nicholas Powley, Saint Paul, MN (US)

(21) Appl. No.: 19/192,093

(22) Filed: Apr. 28, 2025

Related U.S. Application Data
(60) Provisional application No. 63/639,518, filed on Apr. 26, 2024.

(51) Int. Cl. H04L 9/14

(52) U.S. Cl. CPC H04L 9/14

(57) ABSTRACT

Systems and methods for providing one or more users with encryptable and decryptable access to a programmable key portal.

### RELATED APPLICATION

The present application claims the benefit of U.S. Provisional Patent Application No. 63/639,518, entitled “PROGRAMMABLE KEY PORTAL FOR SELECTIVELY CUSTOMIZABLE USER INTERACTION WITHIN A METAVERSE”, filed Apr. 26, 2024, which is herein incorporated by reference in its entirety.

### TECHNICAL FIELD

The present disclosure relates to providing systems, methods, and articles that establish, enable, and incorporate one or more of multiplexing interfaces, metaverses, merchandise encryption or decryption to create one or both of interactive or personalized experiences.

### BACKGROUND

A metaverse is expensive to build and especially prohibitive to personalize. Thus, there is a need for a cost-effective means to provide a personalized metaverse that offers a genuine experience on a virtual reality device providing a 3D environment or a device offering a 2D environment.

Additionally, there is a need for one or both of a system or method that can assist with coordinating access to encrypted, private, or personalized information for users in a more efficient and effective manner.

### SUMMARY

The present disclosure relates generally to systems, methods, and articles that enable users to create interactive experiences for other users, including enabling users to create unique encryption and decryption experiences to access, provide, manage, update, etc. a variety of associated information based on one or more user preferences, associations, careers, influences, etc.

Embodiments of the present disclosure relate to providing a first user with a system or a method for selectively providing one or more second users decryptable content that was once encrypted.

Embodiments of the present disclosure relate to providing a first user with a system or a method for selectively providing a second user with content that was once private. Embodiments of the present disclosure relate to providing a metaverse in which a first user can provide a second user with content that is one or more of selectively discoverable, encrypted, and decrypted. Embodiments of the present disclosure relate to providing a multiplexing interface within a metaverse in which a first user can provide a second user with content that is one or more of selectively discoverable, encrypted, decrypted. Embodiments of the present disclosure relate to provide a multiplexing interface within a metaverse in which a first user can provide a second user with content that is one or more of selectively discoverable, encrypted, or decrypted, and that utilizes a 3rd party system as a means of transmitting one or more signals between decentralized social networking instances.

Embodiments of the present disclosure relate to providing a first user with a system or a method for providing a second user decrypted content that was once encrypted, wherein the content is one or more of a group of or collection of photos. An object of the present invention is to provide a first user with a system or a method for providing a second user decrypted content that was once encrypted, wherein the content is music or otherwise sound related. An object of the present invention is to provide a first user with a system or a method for providing a second user decrypted content that was once encrypted, wherein the content is video or visual/audio recording. An object of the present invention is to provide a first user with a system or a method for providing a second user decrypted content that was once encrypted, wherein the content is mixed media. An object of the present invention is to provide a first user with a system or a method for providing a second user decrypted content that was once encrypted, and wherein the decrypted content that was once encrypted may be updated, changed, or altered. An object of the present invention is to provide a first user with a system or a method for providing a second user decrypted content that was once encrypted, and wherein the decrypted content that was once encrypted may be updated, changed, or altered by the first user, the second user, or alternative individuals.

An object of the present invention is to provide a method for encrypting into a file one or more of data, images, sounds, videos, or other information where the encrypted information is viewable as one or more of data, images, sounds, videos, or other information. An object of the present invention is to provide a method for encrypting into a file one or more of data, images, sounds, videos, or other information where the encrypted information is viewable as one or more of data, images, sounds, videos, or other information provided within a metaverse and accessible via a multiplexing interface or component of a multiplexing interface such as a programmable keyed portal optionally in the form of an elevator floor selection panel. An object of the present invention is to eliminate the need to protect access to one or more files in transit and in storage from attackers or automated scanners. Embodiments of the present invention require a key and an algorithm to recover and ‘see’ the contents of a file whether it be one or more of data, images, sounds, videos, or other information. In one example of the present invention, a digital image contains pixels made up of red, green, and blue values ranging from zero to 255 (24 bit or RGB gamut). In one example of the present invention an image can be serialized as a sequence of values and reconstructed exactly if the width and height are known. In an example of the present a key is a symmetrical encryption key that is a sequence of numbers appearing as pairs of hexadecimal characters from 0 to f, where each pair is convertible to decimal numbers from 0 to 255.

An object of the present invention is steganography. An object of the present invention is steganography within a metaverse. An object of the present invention is steganography within or with one or more of a metaverse or article such as a tag or token.

A method of the present disclosure is comprised of steps described hereafter and here within this paragraph. Wherein the first step of the method, an image is serialized to its RGB values from left to right and top to bottom. Wherein the second step of the method, each value is added to the product of the ordinal position and a large prime number. The prime is selected by the value of a digit in the key. This produces a large, pseudo-random number. Wherein the third step of the method, the resulting large number is brought back into the 0-255 range using the modulo operator. Wherein the fourth step of the method, the pseudo random results are stored in an array then combined into an image file of the same dimension as the original. Wherein the fifth step of the method, the encrypted image can be stored on a memory stick, a server or the cloud. The pseudo random pixel data appears as noise or snow with no perceivable features of the source image besides the dimension. Wherein the sixth step of the method, given the encrypted image and the key the algorithm can restore the original pixel data by subtraction and modulo operators. Wherein the seventh step of the method, the restored pixel data is constituted into an image of the same dimensions as the encrypted file and is identical to the original source image because the algorithm is deterministic. Wherein the eighth step of the method, additionally asymmetric public/private encryption (PGP) could be utilized to eliminate the need to share a single key between the sender and receiver. Optionally, the above method provides the encryption/decryption operation within or between one or more metaverses as or with one or more multiplexing interfaces.

Embodiments of the present disclosure relate to providing a first user with a system or a method to provide a second user with a digital platform comprised of a programmable keyed portal, a multifunctional area or interface, and a content delivery area or interface. An object of the present invention is to provide a first user with a system and a method to provide a second user with a digital platform comprised of a programmable keyed portal, a multifunctional area, and a content delivery area, where the multifunctional area acts as either an input or an output. An object of the present invention is to provide a first user with a digital platform comprised of a system and a method to provide a second user with a programmable keyed portal, a multifunctional area, and a content delivery area, where the multifunctional area acts as either an input or an output depending upon the input to the programmable keyed portal. An object of the present invention is to provide a multifunctional area that appears and disappears as needed, expands or collapses as needed, or is integrated into one or more other areas of the interface, such as the content delivery area. An object of the present invention is to provide a first user with a digital platform comprised of a system and a method to provide a second user with a programmable keyed portal, a multifunctional area, and a content delivery area, where the multifunctional area acts as either an input or an output depending upon the portal of the physical article by which the second user arrived at the digital platform or through a multiplexing interface of a metaverse.

Embodiments of the present disclosure relate to providing a first user with a system or a method to provide a second user with an article of clothing or object that allows the second user to access decrypted information that was previously encrypted, such as a piece of merchandise, wearable article, luxury, etc. that allows the second user to access decrypted information that was previously encrypted.

Embodiments of the present disclosure relate to providing a first user with a system or a method for providing a second user decrypted content that was once encrypted and continues to be encrypted relative to additional users or others who may scrutinize the content.

Embodiments of the present disclosure relate to creating or recall an olfactory experience. An object of the present invention is to recall an olfactory experience.

Embodiments of the present disclosure relate to providing one or more users with a multiplexing interface that is intuitive and in one or more embodiments is presented as a metaverse. An embodiment of the present invention is to provide the user with a multiplexing interface including at least a first portion and a second portion, where the first portion and the second portion are spatially related. In embodiments, the first portion is a programmable keyed portal, and the second portion is an arrangement of at least one portal, link, programmable keyed portal, display, section for one or more applications or links, etc. In embodiments the second portion may be one or more of a third party service delivered therein or an additional programmable keyed portal.

Embodiments of the present disclosure relate to providing the at least first portion and second portion and allows one or more users to transition between the first portion and the second portion with one or more actions. Embodiments of the present disclosure relate to providing a first or second portion a programmable keyed portal in the form of an elevator, a keypad, a piano, a bookcase, or other graphical or geometric arrangement. Embodiments of the present disclosure relate to providing a programmable keyed portal that is accessible by people without sight. Embodiments of the present disclosure are comprised of a programmable keyed portal where the programmable keyed portal utilizes one or more of a refreshable braille display, electronic braille, or other option or device to maximize accessibility.

Embodiments of the present disclosure relate to providing a multiplexing interface of the present invention is presented as a metaverse. Embodiments of the present disclosure relate to providing a multiplexing interface of the present invention is presented as a metaverse that multiplexes decentralized social networking instances. Embodiments of the present disclosure relate to providing a multiplexing interface of the present invention is presented as a metaverse that multiplexes social networking instances. Embodiments of the present disclosure relate to providing a multiplexing interface of the present invention is presented as a metaverse that multiplexes third party services. Embodiments of the present disclosure relate to providing a multiplexing interface of the present invention is presented as a metaverse that multiplexes third party services such as one or more virtual meeting services such as Google Meet®, WhatsApp®, Zoom®, Clubhouse®, or the like. Embodiments of the present disclosure relate to providing a multiplexing interface wherein users arrive at one or more gates such as a forced login, request for contact information, or simple password requirement, where when satisfied, allows the user to access one or more desirable outcomes including but not limited to content or connectivity. Embodiments of the present disclosure relate to providing a multiplexing interface wherein the presence of one or more users is visible to one or more users. Embodiments of the present disclosure relate to providing a multiplexing interface wherein the presence of one or more users is visible to one or more users and appears as encouragement to engage or participate in one or more available options or activities.

Embodiments of the present disclosure relate to providing an interface of the present invention that provides a method of reaching a destination comprised of a first available step and a second available step. Embodiments of the present disclosure relate to providing an interface of the present invention that provides a method of reaching one or more destinations comprised of a first available step and a second available step, where each of the steps may be optionally selected, used, or utilized by a user to arrive at one or more destinations. Embodiments of the present disclosure relate to providing an interface of the present invention that provides a method of reaching a destination comprised of a first available step and a second available step, wherein the first available step is comprised of entering a code into a programmable keyed portal and the second available step is comprised of clicking a link. Optionally the first step and the second step may be separated by one or more activities. One such activity is scrolling, swiping, or other like motions from or between at least the first portion to and from the second portion. Embodiments of the present disclosure relate to providing an interface of the present invention that provides a method of reaching a destination comprised of a first available step and a second available step, where the first step and the second step are separated by an activity and able to be taken independently.

The multiplexing interface of the present invention may be comprised of a programming or programmable interface.

Embodiments of the present disclosure relate to providing a multiplexing interface that is connected to or provided with a social networking interface. The social networking interface allows one or more users to enter and execute commands that adapt the social networking interface or the multiplexing interface. A multiplexing interface provides one or more users the ability to sell art between floors of a metaverse.

Embodiments of the present disclosure relate to providing a multiplexing interface comprised of two or more links that are presented as two or more users as penthouses, where the invention allows one user to sell art, memorabilia, or other products to the other user and in doing so transfer the art, memorabilia, or other products between the penthouses and between the users. Embodiments of the present disclosure relate to providing a multiplexing interface where when a transaction happens in the metaverse, a related transaction happens in the real world or universe. Embodiments of the present disclosure relate to providing a multiplexing interface where when a transaction happens in the metaverse, one or more systems of the present invention cause or enable a related transaction to happen in the real world or universe.

Embodiments of the present disclosure relate to providing an interface presented on a screen. An interface of the present invention is presented on or within a virtual reality headset. An interface of the present invention is presented to the user via a brain interface. An interface of the present invention is presented to the user such that interface uses a haptic stylus or haptic feedback system. An interface of the present invention is presented to the user such that interface uses one or more braille systems. An interface of the present invention is presented to the user such that interface uses one or more systems for the visually, hearing, or otherwise impaired or relatively limited.

Embodiments of the present disclosure relate to providing a system of the present invention that is comprised of an interface presenting selectively, interactivity in one, two, three, or more dimensions. A system of the present invention is comprised of an interface that expresses sound as a means to enable a user to traverse one or more dimensions of the interface. Embodiments of the present disclosure relate to provides the interface presenting interactivity in one, two, three, or more dimensions within a computer system and one or more dimensions in real life. Dimensions include but are not limited to spatial dimensions, temporal dimensions, and more ethereal properties relating presence or absence, or to scarcity or abundance such as money, ownership, or control.

Embodiments of the present disclosure relate to providing a system of the present invention, comprising a physical article that acts as a portal to the interface, where the physical article is comprised of one or more anti-counterfeiting features. Embodiments of the present disclosure relate to providing a system of the present invention, comprising a physical article this is further comprised of a portal and a key that together allow access to the interface.

Embodiments of the present disclosure relate to providing an interface primarily comprised of comments. Embodiments of the present disclosure relate to providing an interface primarily comprised of geographically arranged comments. Embodiments of the present disclosure relate to providing an interface primarily comprised of comments that are geographically arranged in table. Embodiments of the present disclosure relate to providing an interface primarily comprised of comments that are geographically arranged in a table and presented with one or more of additional or related data or metadata. Embodiments of the present disclosure relate to providing an interface primarily comprised of comments further comprised of interface elements that enable ranking, the documentation of completeness, or one or more hyperlinks to one or more of another system or interface.

Embodiments of the present disclosure relate to providing a decentralized social networking system on a peer-to-peer basis that utilizes the Interactivity Communications Establishment (ICE) protocol. Embodiments of the present disclosure relate to a method for providing a decentralized social networking system on a peer-to-peer basis whereby the means to connect on a peer-to-peer basis is achieved by first downloading a software when an internet connection is available and second by utilizing the software when an internet connection is not available. Embodiments of the present disclosure relate to a method for providing a decentralized social networking system on a peer-to-peer basis whereby the means to connect on a peer-to-peer basis is achieved by providing a device at a point of sale that incorporates a software and second by utilizing the software when an internet connection is not available. Embodiments of the present disclosure relate to a method for providing a decentralized social networking system on a peer-to-peer basis whereby the means to connect on a peer-to-peer basis is achieved by first downloading an event ticketing software when an internet connection is available and second by utilizing the software when an internet connection is not available. Embodiments of the present disclosure relate to a method for providing a decentralized social networking system comprised of a first scanning step, a second scanning step, and a processing step where the first and second scanning steps input at least two keys that are processed into decentralized social networking software. Embodiments of the present disclosure relate to a method for providing a decentralized social networking system comprised of a first scanning step, a second scanning step, and a processing step where the first and second scanning steps input at least two keys that are processed via classical or quantum code breaking methods into decentralized social networking software. Embodiments of the present disclosure relate to a method for providing a decentralized social networking system comprised of at least three scanning steps, and a processing step where the first and second scanning steps input at least two keys that are processed via code breaking methods into decentralized social networking software, where further the processing is accelerated by the third key that is input by the third scanning step.

In an embodiment, a method for generating a social network system includes connecting, by a user interface, a plurality of available websites each with at least one unique URL and at least one associated unique programmed key; creating a set of tags, wherein each tag in the set of tags includes a QR code and a personalization area, such that the QR code directs a user to the user interface and the personalization area includes at least one unique programmed key; providing a tag among the set of tags with the QR code and at least one unique programmed key to a user; and scanning the QR code, by the user, with a user device; subsequent to scanning the QR code, presenting to a user device, the user interface configured to enable selection of one of the plurality of available websites based on a programmed key associated with the one of the plurality of available websites. In embodiments, the method further comprising enabling the user to define access permissions and otherwise customize the selected website via the user interface.

In an embodiment, a method for generating a personalized user experience includes associating a plurality of available websites each with a unique URL, creating a set of tokens or tags, wherein each token or tag in the set of tokens or tags includes an area for a programmed key, optionally to be hand written, and an area for an autograph, optionally to be hand written, and a QR code linked to a programmable keyed portal where each programmed key of the programmable keyed portal is associated with one of the plurality of available websites, presenting to a user device, a user interface configured to enable selection of one of the plurality of available websites via the user interface.

In an embodiment, a personalized user experience includes accessing an online database of a plurality of available websites each with a unique URL, creating a set of tokens or tags, wherein each token or tag in the set of tokens or tags includes an area for a programmed key and an area for an autograph, and a QR code linked to a programmable keyed portal where each programmed key of the programmable keyed portal is associated with one of the plurality of available websites, presenting to a user device, a user interface configured to enable selection, via entry of the programmed key, of one of the plurality of available websites via the user interface.

In an embodiment, a personalized user experience includes an aggregator, optionally available via the programmable keyed portal, that accesses content associated with the plurality of available websites.

In an embodiment, a personalized user experience includes an aggregator, optionally available via the programmable keyed portal, that accesses content associated with the plurality of available websites, and makes that content interactive by using an Application Programming Interface (API) belonging to one or more of the plurality of available websites.

A metaverse of the present invention with two or more spatial dimensions comprises one or more towers with one or more elevators.

A metaverse of the present invention comprises three or more spatial dimensions. Optionally, a three dimensional metaverse can be reduced to a two-dimensional metaverse for ease of viewing on a two dimensional viewer.

Optionally, additional spatial dimensions exist as parameterized paths within or in relation to lower or mismatched dimensional spaces. Optionally, one or more spatial dimensions can exist with relevance to one or more users exclusively.

Optionally, one or more temporal dimensions exist as parameterized paths within lower or mismatched dimensional spaces. Optionally, one or more temporal dimensions can exist with relevance to one or more users exclusively.

Optionally, an elevator representing one embodiment of a programmable keyed portal may be presented as a floor or space within a building or tower, or alternatively or simultaneously, an elevator may be represented by antennae atop one or more building or tower.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is an illustration of a high-level diagram representing a network or network of networks and their potential connectable configurations.

FIG. 2 is a schematic diagram of a network, according to an embodiment.

FIG. 3 is a flow chart of a method utilizing a physical article to facilitate access to encrypted or non-encrypted information, according to an embodiment.

FIG. 4A is an illustration of a front view of a programmable key portal token, according to examples.

FIG. 4B is an illustration of a back view of a programmable key portal token, according to examples.

FIG. 4C is an illustration of a side view of a programmable key portal token, according to examples.

FIG. 5A is an illustration of a front view of a programmable key portal token, according to examples.

FIG. 5B is an illustration of a back view of a programmable key portal token, according to examples.

FIG. 5C is an illustration of a side view of a programmable key portal token, according to examples.

FIG. 6A is an illustration of a front view of a programmable key portal token, according to examples.

FIG. 6B is an illustration of a back view of a programmable key portal token, according to examples.

FIG. 6C is an illustration of a side view of a programmable key portal token, according to examples.

FIG. 6D is an illustrative diagram of facilitating access to an encrypted information platform via decryption with a physical article comprised of a portal and a key, according to examples.

FIG. 7 is an illustrative diagram of a multiplexing interface and metaverse comprised of a first portion and a second portion where the first portion incorporates a programmable key portal and the second portion incorporates one or more links, according to examples.

FIG. 8 is an illustrative diagram of an interface for haptic feedback during use, according to examples.

FIG. 9A is an illustrative diagram of multiplexing interfaces of a metaverse of the present invention.

FIG. 9B is an illustrative diagram of multiplexing interfaces of a metaverse of the present invention.

FIG. 9C is an illustrative diagram of multiplexing interfaces of a metaverse of the present invention.

FIG. 10A is an illustrative diagram showing a metaverse with multiplexing interfaces, programmable keyed portals, floors or tokens to provide users with personalized experiences.

FIG. 10B is an illustrative diagram representing communication or signal pathways between metaverses with multiplexing interfaces.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The present disclosure presents a system and method whereby an individual or a group of people can privately, or in an online location with a singular purpose or multiple purposes, share websites, social networks, videos, photos, information, or other forms of data for a particular purpose, event, career, influence, influencers, or other various forms of context with ease. To accomplish this end, a personalized programmable key portal network can be generated for one or more individuals or a group to enhance privacy and security of the information, but enable an ease of interaction under certain circumstances, as described herein. The personalized programmable key portal can be associated with a place, time, career, or other personalized conditions, such that the programmable key portal can effectively address a purpose, such as sending, receiving, interacting, updating various forms of information (e.g., enabling decrypted access to websites, photos, videos, data, etc.).

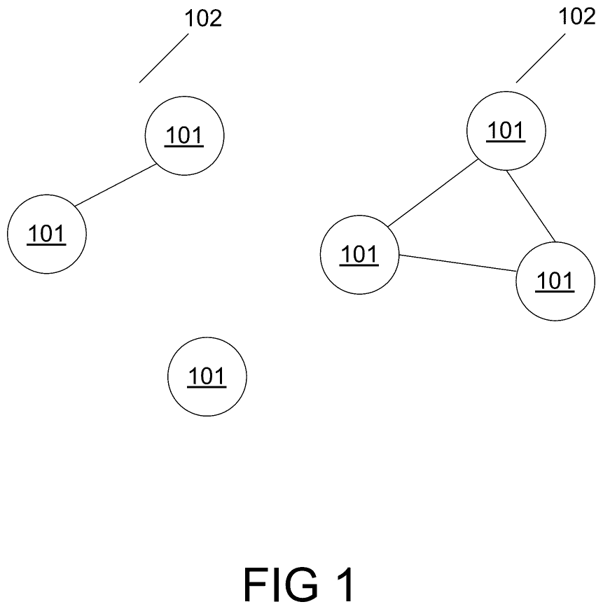

FIG. 1 depicts a network 101 or a network of networks 102 that may be associated with a website, social network, or other communications for a particular event and accessible by one or more members of a group. Each network 101 may be communicatively connected between each other. In embodiments, each network 101 may establish a possible connection between the network 101 or networks 102 they represent and other networks. In embodiments, individual networks 101 or networks of networks 102 may be invisible or visible to other networks 102. In embodiments, a visible network may not be connectable to other networks. Networks 101/102 may publish or subscribe to other networks and may call for the publication of content from other networks. In embodiments, networks 101/102 may exist and connect to each other via the internet or world wide web. In embodiments, networks 102 can exist may connect to each other via the Interactive Connectivity Establishment (ICE) Protocol, exclusive of an internet or world wide web connection. Networks 101/102 may exist and connect to each other vie the ICE Protocol with supplementary connectivity via an internet or world wide web connection.

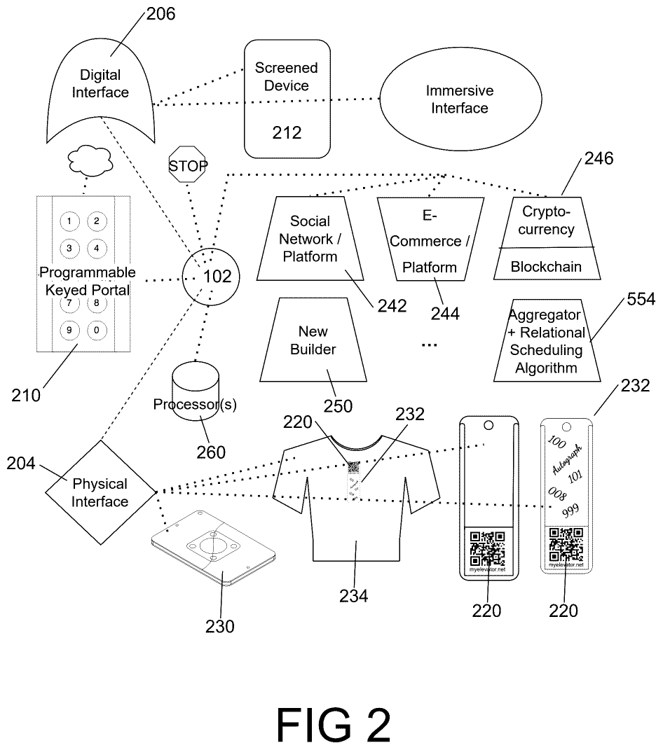

FIG. 2 depicts a high-level diagram of each network or network of networks 102. In embodiments, each network or network of networks 102 may comprise a physical interface 204 and a digital interface 206. The physical interface 204 and the digital interface 206 are communicatively connected such that the physical interface 204 transports a user to the digital interface 206. In embodiments, the digital interface 206 may include a programmable keyed portal 210, accessible through a screened device 212 (e.g., cellphone, computer, etc.), that connects the physical interface 204 to the digital interface 206 such that the programmable keyed portal 210 transports a user from the physical interface 204 to the digital interface 206. The digital interface 206 is configured to transport a user to a variety of network platforms based on programmable keyed portal 210 input. In embodiments, the physical interface 204 may include one or more tokens (not depicted), a writeable tag 232, an article (not depicted), a textile article 234, a box (including additional items for transporting a user to a digital interface) 230, etc. that includes information to be inputted in the programmable keyed portal 210 which directs the user to a particular network/platform. In embodiments, a user may create or access their own social network/platforms, portable to their own URL and their own virtual server. In embodiments, a user may access other social networks/platforms not created or owned themselves. The virtual server comprising a social networking layer 242, an ecommerce layer 244, a blockchain 246, a cryptocurrency layer 248, etc., wherein the virtual server may utilize processing power provided by any processor 260. In embodiments, the virtual server may comprise a new builder layer 250 in which information may be added, deleted, modified etc. by one or more users that have access to the virtual server. In embodiments, the virtual server may comprise a new builder layer 250 with which a new network 102 can be created and connected.

In embodiments, each member of a group may be given a unique token or ID card. Each token can be assigned a unique identifier specific to a user, event, or both. In such embodiments, each token can include a QR code 220 incorporating a graphic identifying a user or event associated with the token. In embodiments a radio frequency identification (RFID) tag or near field communication (NFC) can also be incorporated into each token to provide further connectivity and association capabilities.

In embodiments, tokens can be created as part of a set or group such that all tokens of a set can communicatively access a private website or social network. The group of tokens and accompanying website or social network can then be customized for purposes specific to an event.

In embodiments, a marrying couple can plan their wedding and associated products and services well in advance. The marrying couple can be given or purchase a group of tokens and then customize an associated social network to their preferences. In embodiments, the associated social network can include information about one or more of a time for the wedding, a venue, a gift registry, a guest list, an assigned table layout, a gallery of pictures, or other information relevant to a couple's wedding. In embodiments, a live feed of the wedding may be captured and broadcast to remote audiences via the private social network or website.

In embodiments, a user can pay up front for the tokens. In some embodiments, the tokens can be packaged with other goods or services to simplify the planning process for an event. As such, it becomes possible to quickly aggregate a plurality of goods and services associated with an event in a private social network. The private social network can then be used to track expenses and details for the event separate from functionality associated with connecting guests.

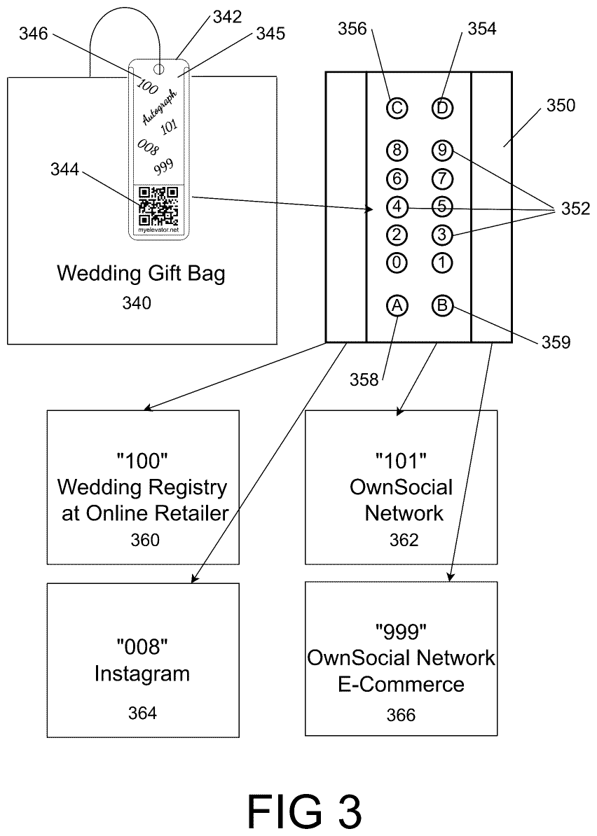

FIG. 3 depicts an article, such as a wedding gift bag 340, implemented with a tag 342 as described herein. In embodiments, the tag 342 may include an autograph area 345 such that a person may autograph or write information on the tag 342 intended for an attendee of an event, such as a wedding. The tag may correspond to a link to a website or digital place in which the recipient may be directed. In embodiments, a person receiving the wedding gift bag 340 with the tag 342 may follow the link to a website or digital place via scanning an associated QR code 344. In embodiments, one or more code stings 346 may be provided to the recipient as part of the autographing of the tag 342. For example, a code string 100 may be written on tag 342. When an attendee scans the QR code 344 and is directed to a programmable keyed portal 350, the attendee may input the code string into the digital interface, in which case the attendee will be directed to a wedding registry at an online retailer 360 (i.e. an alternative website or digital place). In yet another example, attendee may input code string 101, in which case the attendee is directed to their own, individually created “OwnSocial” network 362. In yet another example, attendee may input code string 008, in which case the attendee may be directed to a more public website or digital place, such as Instagram 364, Facebook, Twitter, etc. In yet another example, attendee may input code string 999, in which case the attendee is directed to their own, individually created “OwnSocial” network E-commerce 366.

In embodiments, a digital interface for code string input may be a programmable keyed portal 350, much like a floor level input interface of an elevator, with a plurality of input capabilities (e.g., buttons). In embodiments, the code string input may be extended from 1 to n digits associated with 1 to n input capabilities 352 integrated into the programmable keyed portal 350 to direct the user to a website or digital place. Symbols outside digits 0, 1, 2, . . . 9 may be any string of symbols from the keys available on the programmable keyed portal 350 as a string of any symbols. In embodiments, the programmable keyed portal may include a variety of other possible inputs such as a directory input 352 which may be selected and may direct the user to a directory of code strings each associated with a particular website or virtual place. In embodiments, the directory may be pre-populated with a plurality of code strings. Additionally, the directory input 352 may be configured to call an open channel line, wherein the open channel line is accessible to all who have access to tag(s) 346/QR code(s) 344. For example, attendees of the event, such as a wedding, and those that received the gift bag may have access to the tag 346/QR code 344. After obtaining access and opening up the programmable keyed portal, those who choose to call the open line, via the directory input 356, may speak with each other via the open call line[RLS2].

In embodiments an interactive aggregator 354 aggregates content from digital target channels (e.g., 360, 362, 364, 366) associated with the programmable keyed portal 350. In embodiments an interactive aggregator 354 aggregates content from digital target channels associated with the programmable keyed portal 352 and plays them in an order that is dictated by a relational scheduling algorithm (e.g., in a predetermined priority order based on user preferences). In embodiments an interactive aggregator 354 aggregates content from digital target channels associated with the programmable keyed portal 352 and plays them in an order that is dictated by a relational scheduling algorithm that learns what content each user prefers and provides each user with the most preferable content on the basis of the user's preferences. In embodiments an interactive aggregator 354 aggregates content from digital target channels) associated with the programmable keyed portal 352 and plays them in an order that is dictated by a relational scheduling algorithm that learns what content users prefer with a genetic algorithm. In embodiments an interactive aggregator 354 aggregates content from digital target channels associated with the programmable keyed portal 352 and plays them in an order that is dictated by a relational scheduling algorithm that learns what content users prefer by utilizing a genetic algorithm comprised of a randomization function and selection criteria. In embodiments an interactive aggregator 354 aggregates content from digital target channels associated with the programmable keyed portal 352 and plays them in an order that is dictated by a relational scheduling algorithm that learns what content and categories of content users prefer by utilizing a genetic algorithm comprised of a randomization function that offers content and categories of content in new sequences and selection criteria that are used to select for sequences of content, and for example categories, that maximize user engagement.

In embodiments, the programmable keyed portal may include a start/stop input 358 or a reset input 359, or both. The start/stop input 358 is configured to start and stop music (facilitated/gathered through the aggregator 354). The reset input is 359 configured to reset music facilitated by the aggregator 354 or reset a partial code string inputted by a user. In embodiments, the autograph area can comprise a QR code, near field communication tag or chip, or an RFID tag associated with a personalized website or social network. In embodiments, an article may include a tag that enables a person with an autograph pen in hand to autograph the article, for example a shirt. By providing the autographed shirt to a fan, the fan may follow a link to a website or digital place associated with the tag. In embodiments, an article may include a tag that enables a person with an autograph pen in hand to autograph an article, for example a shirt, with one or more accompanying codes. In embodiments, the code may be written on the tag from the signer, provided vocally, written separately, or the like. By providing the autographed shirt to a fan, the fan may follow a link to a website or digital place associated with the tag and enter a code to reach another website or digital place.

In embodiments, an autograph area of a shirt or article of clothing can be less stretchy, have a higher modulus, and be less absorbent than the rest of the article on which the autograph area is placed to facilitate writing with a pen or other writing instrument on the autograph area. In embodiments, an autograph area may be printed, labeled, tagged, removably tagged, applied, or the like.

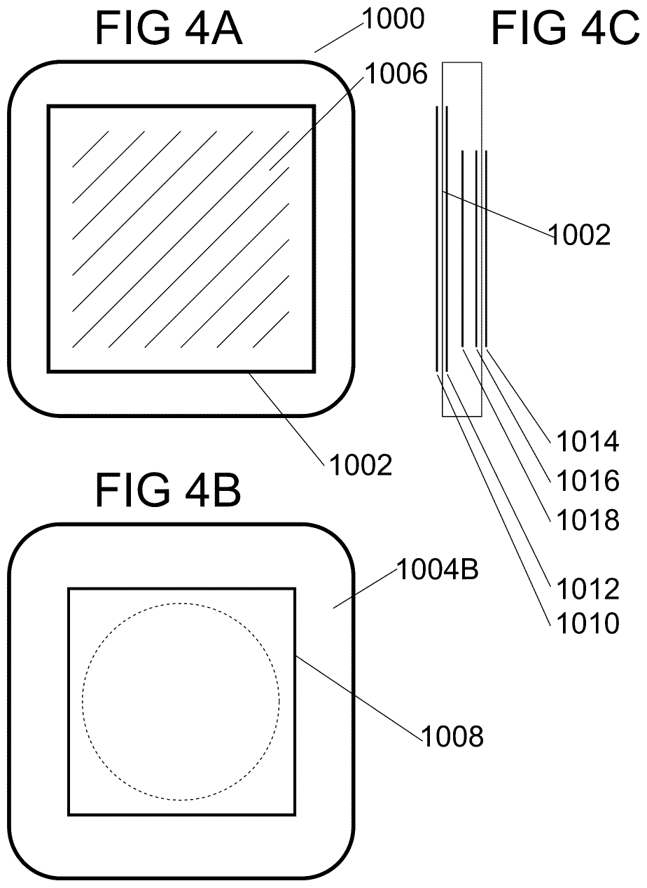

FIGS. 4A-4C are illustrations of a front view, rear view, and side view, respectively, of a programmable key portal token, according to examples. In examples, a physical article, such as a token 1000 may be available to a user. The front view of token 1000 may include an inner portion 1002 and an outer portion 1004A (e.g., an outer edge or border relative to the inner portion 1002). In examples, inner portion 1002 may be configured to include a first scannable or interactive medium 1006, such as one or more quick response (QR) codes, Near Field Communication (NFC) chips, Radio Frequency Identification (RFUD) chips, etc. for programmable access, interaction, and encryption/decryption by one or more users. In examples, first scannable or interactive medium 1006 may be configured as a key that enables decryption of content that may unlock or enable access, view, alteration, updating, etc. to information, such as photos, websites, sound, music, videos, mixed media, etc., as described further herein. In examples, first scannable medium 1006 may be painted, colored, or otherwise illustrated on the surface of the token 1000, which may be reflected on the surface 10010 of token 1000. In examples, first scannable medium 1006 may be etched, carved, or otherwise integrated into the surface of the token 1000, which may be reflected into the surface 1012 of token 1000.

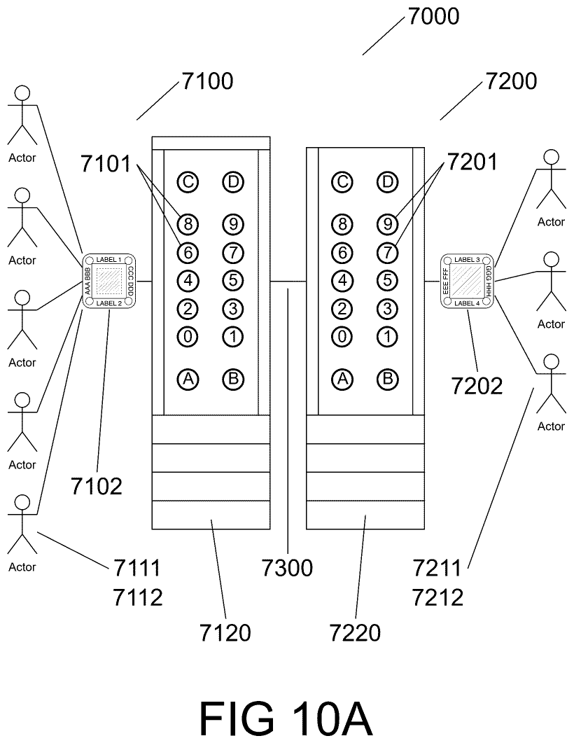

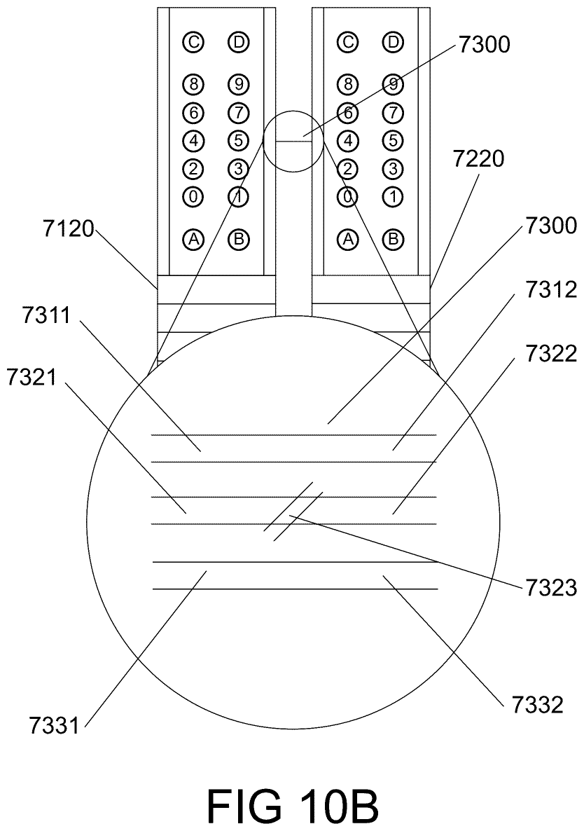

In examples, the rear view of token 1000 (FIG. 10B) may depict a second scannable or interactive medium 1008, coupled with token 1000, within or about inner and outer portion 1004B. In examples, second scannable or interactive medium 108 may include one or more QR codes, NFC chips, Radio Frequency Identification (RFUD) chips etc. for programmable access, interaction, and encryption/decryption by one or more users. In examples, second scannable or interactive medium 1008 may be configured as a portal that enables access or interaction for a user to initiate a decryption process of content that to unlock or enables access, view, alteration, updated, etc. to the information, such as photos, websites, videos, mixed media, etc., as described further herein. In examples, second scannable medium 1008 may be painted, colored, or otherwise illustrated on the rear facing surface 1014 of the token 1000. In examples, second scannable medium 1008 may be etched, carved, or otherwise integrated into the rear facing surface 1016 of the token 1000. In examples, second scannable medium 1008 may be coupled within token 1000. For example, an NFC chip configured to initiate the decryption process (further described with reference to FIG. 30D) may be couple within token 1000 at or near position 1018. In examples, within position 1018, second scannable medium 108 may be scannable by a user, but not necessarily visible to the user.

In examples, token 1000 (and other physical articles as described herein) may be constructed out of various, suitable material. Such material may comprise of plastic, metal, wood, etc. In examples, while a square or otherwise rectangular shape may be depicted herein, alternative shapes of token 1000 are considered. Such shapes and designs may include circular, oval, triangular, octagonal, etc. shapes. It should be noted that, while various examples may be described herein, other materials, shapes, sizes, etc. are contemplated. In examples, inner portion 1002 has an area available to maximize the effectiveness and reliability of first interactive medium 1006. For example, providing a larger, clearer first interactive medium 1006 (e.g., QR code) may enable the user initially scanning the second interactive medium 1008 more effective scanning, processing, and otherwise further accessing the information associated with the first interactive medium 108.

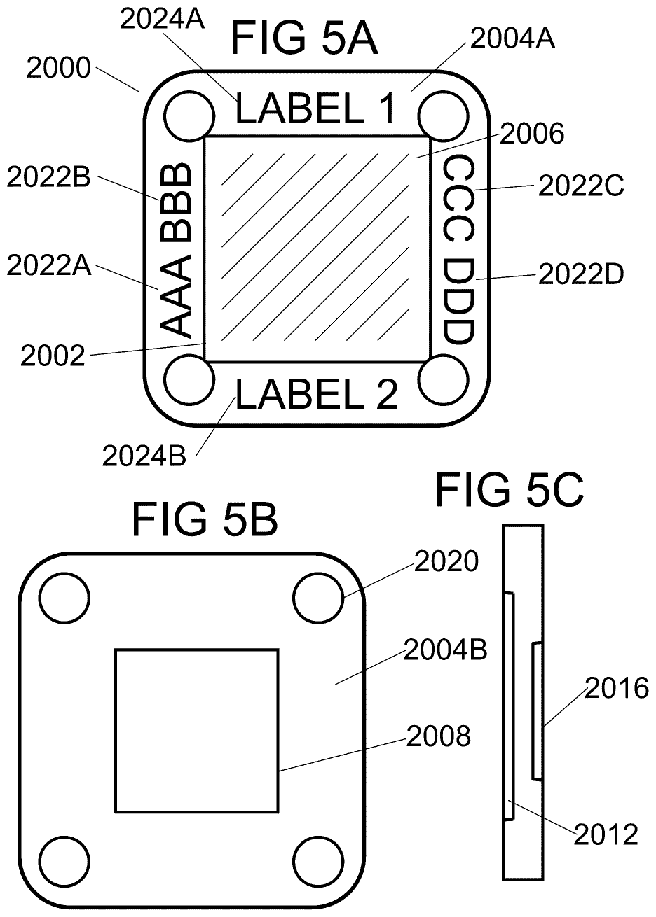

FIGS. 5A-5C are illustrations of a front view, rear view, and side view, respectively, of a programmable key portal token, according to examples. In examples, token 2000 may be similar to and include one or more similar features as token 1000. For example, token 2000 may be a physical article, such as token 2000, which may be available to a user. A front view of token 200 may include an inner portion 2002 and an outer portion 2004A (e.g., an outer edge or border relative to the inner portion 2002). In examples, inner portion 2002 may be configured to include a first scannable or interactive medium 2006, such as one or more quick response (QR) codes, Near Field Communication (NFC) chips, Radio Frequency Identification (RFUD) chips, etc. for programmable access, interaction, and encryption/decryption by one or more users. In examples, first scannable or interactive medium 206 may be configured as a key that enables decryption of content that may unlock or enable access, view, alteration, updating, etc. to information, such as photos, websites, sound, music, videos, mixed media, etc., as described further herein. In examples, first scannable medium 2006 may be etched, carved, or otherwise integrated into the surface of the token 2000, which may be reflected into the surface 2012 of token 2000.

In examples, token 2000 may similarly include a second scannable or interactive medium 2008, coupled with token 2000. In examples, second scannable or interactive medium 2008 may include one or more QR codes, NFC chips, Radio Frequency Identification (RFUD) chips, etc. for programmable access, interaction, and encryption/decryption by one or more users. In examples, second scannable or interactive medium 208 may be configured as a portal that enables access or interaction for a user to initiate a decryption process of content that may be facilitated to provide a process to unlock or enables access, view, alteration, updated, etc. to the information, such as photos, websites, videos, mixed media, etc., as described further herein. In examples, second scannable medium 2008 may be painted, colored, or otherwise illustrated on the rear facing surface 2014 of the token 2000. In examples, second scannable medium 2008 may be etched, carved, or otherwise integrated into the rear facing surface 2016 of the token 2000.

In examples, token 2000 may include one or more additional features to assist in the overall use or function to the user. For example, token 2000 may include one or more hollow openings 2018. In examples, the hollow openings 2020 may enable a user to intertwine or otherwise couple token 2000 to various articles for use. For example, a string, band, rope, etc. may be intertwined through and between the one or more hollow openings 2020 such that token 2000 may be coupled, tied to, or otherwise secured to a person or object. In examples, token 2000 may be secured, tied, or otherwise coupled to a user (e.g., similar to a wristband, ancle bracelet, forehead strap, etc.).

In examples, token 2000 may include additional or alternative features surrounding among outer portion 2004A, for example, within outer portion 2004A may include one or more additional keys or key codes 2022A-D to be available for a user of token 20000. In examples, one or more key codes 2022A-D may be utilized in addition to or as an alternative to key 2006 for access to additional or alternative photos, videos, websites, data, information, etc. (described in greater detail with reference to FIG. 3D). In examples, following the scanning or interaction with second interactive medium 2008 by a user, via an electronic device (e.g., scanning the NFC chop via a cell phone), a user may be provided an option to scan the first interactive medium 2006 to decrypt encrypted information programmed associated with the token 2000 or be prompted to manually enter one of the one or more key codes 2022A-D to access additional or alterative information. In examples, one or more key codes 2022A-D may be available to a user such that decryption of such associated content is not necessary and may be readily available to a user based on prompted input of the one or more key codes 2022A-D following scanning of second interactive medium 208.

In examples, token 2000 may be configured to include one or more labels, brands, advertisement, promotions, or other various content 2024A-B. Such content 2024A-B may be coupled to token 2000 in a variety of ways, such as etched, printed, painted, attached via an adhesive, etc. to enable secure, temporary, or permanent coupling to token 200. It should be understood that, while multiple hollow openings 2020, key codes 2022A-D, and content 2024A-B have been illustrated, alternative variations, sizes, arrangements, etc. are contemplated and the examples provided merely for illustrative purposes and are not therefore limiting.

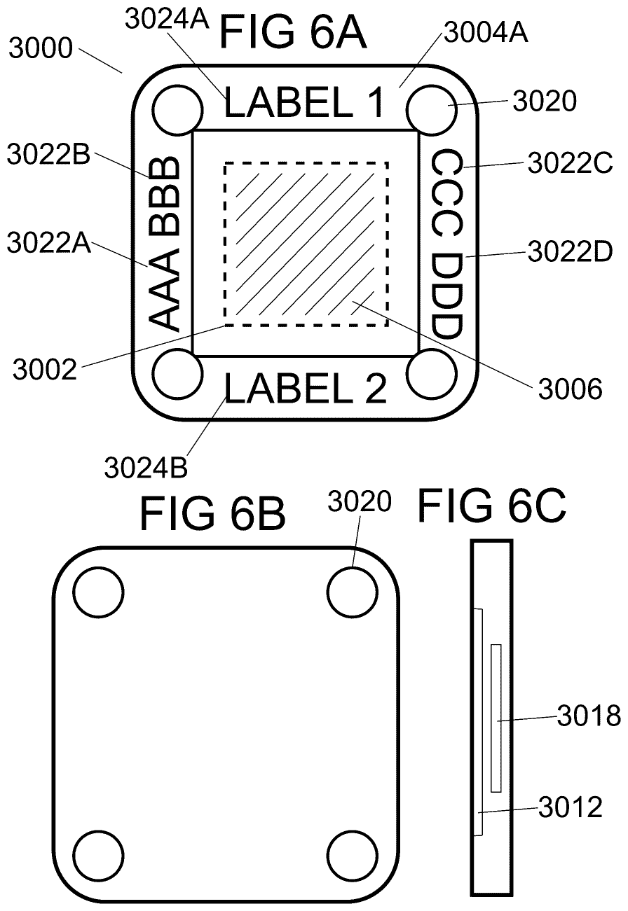

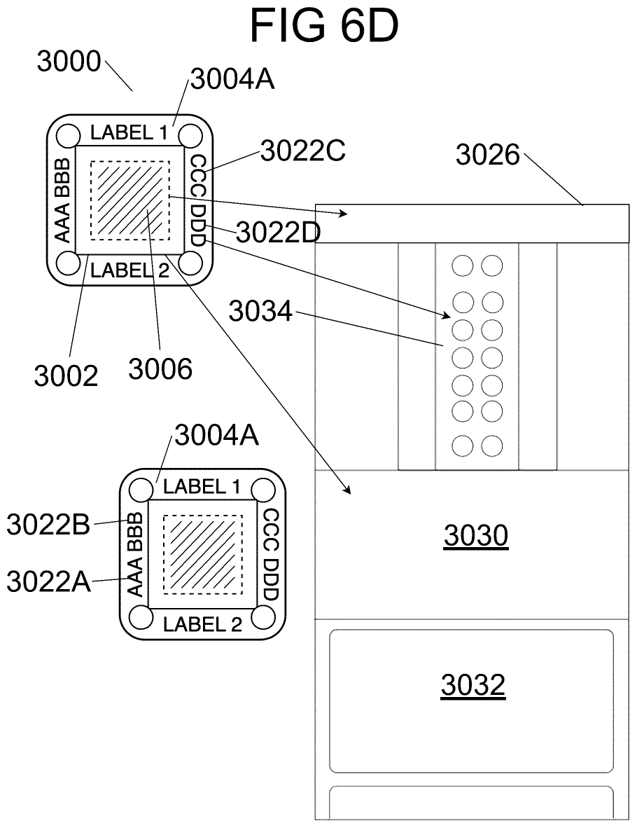

FIGS. 6A-6C are illustrations of a front view, rear view, and side view, respectively, of a programmable key portal token, according to examples. In examples, token 3000 may be similar to and include one or more similar features as token 1000 or 2000. In examples, token 3000 may include one or more of the same or similar components. For example, such components may include an inner portion 3002 and an outer portion 3004A (e.g., an outer edge or border relative to the inner portion 3002). In examples, inner portion 3002 may be configured to include a first scannable or interactive medium 3006, such as one or more QR codes, NFC chips, RFUD chips, etc. for programmable access, interaction, and encryption/decryption by one or more users. In examples, first scannable or interactive medium 3006 may be configured as a key that enables decryption of content that may unlock or enable access, view, alteration, updating, etc. to information, such as photos, websites, sound, music, videos, mixed media, etc., as described further herein. In examples, first scannable medium 306 may be etched, carved, or otherwise integrated into the surface of the token 300, which may be reflected into the surface 3012 of token 3000.

In examples, token 3000 may similarly include a second scannable or interactive medium 3018, coupled within token 3000. In examples, second scannable or interactive medium 3018 may include one or more QR codes, NFC chips, RFID chips, etc. for programmable access, interaction, and encryption/decryption by one or more users. In examples, second scannable or interactive medium 3018 may be configured as a portal that enables access or interaction for a user to initiate a decryption process of content that may be facilitated to provide a process to unlock or enables access, view, alteration, updated, etc. to the information, such as photos, websites, videos, mixed media, etc., as described further herein. In examples, second scannable medium 3018 may be etched, carved, or otherwise integrated 3018 into the rear facing surface of the token 3000.

Similarly to physical articles described herein, token 3000 may include one or more additional features to assist in the overall use or function to the user. For example, token 3000 may include one or more hollow openings 3020, which may enable a user to intertwine or otherwise couple token 3000 to various articles for use. Additionally, for example, token 3000 may include additional or alternative features surrounding among outer portion 3004A. For example, within outer portion 3004A may include one or more additional keys or key codes 3022A-D to be available for a user of token 3000. In examples, one or more key codes 3022A-D may be utilized in addition to or as an alternative to key 3006 for access to additional or alternative photos, videos, websites, data, information, etc. In examples, following the scanning or interaction with second interactive medium 3018 by a user, via an electronic device (e.g., scanning the NFC chop via a cell phone), a user may be provided an option to scan the first interactive medium 306 to decrypt encrypted information programmed associated with the token 3000 or be prompted to manually enter one of the one or more key codes 3022A-D to access additional or alterative information. In examples, one or more key codes 3022A-D may be available to a user such that decryption of such associated content is not necessary and may be readily available to a user based on prompted input of the one or more key codes 3022A-D following scanning of second interactive medium 3018. In examples, token 3000 may be configured to include one or more labels, brands, advertisement, promotions, or other various content 3024A-B.

In examples, with further reference to FIG. 6D, first and second scannable or interactive mediums 3006 and 3018 (or other variations of first and second scannable interactive mediums as described herein) may be configured to be function collaboratively, such that access to an encrypted or non-encrypted digital platform 3026 is accessible to access information based on the scanning or input of the one or more first scannable medium 3006 and second scannable medium 3018 by a user. In examples, second interactive medium 3018 may be scanned by a user. For example, a user may utilize a mobile device (e.g., cell phone), such that it scans and recognizes an NFC chip within or otherwise coupled to token 3000. Thus, second interactive medium 3018 functions as a portal for initial interaction and to facilitate the process to access the encrypted or decrypted information, as described herein. In examples, once second interactive medium 3018 has been scanned, the digital platform 3026 may become available for view and interaction by the user. Once available, the user may be presented with multiple different options (e.g., “portals”) to access, view, update, etc. information associated with the token 3000. First interactive medium 3006, one or more key codes 3022A-B, and any other incorporated “keys” associated with the token 3000 may then be input or scanned within the digital portal 3026 to provide users with the correlated information.

In examples, physical article, such as a token 3000 and a digital platform 3026 may utilize one or more second interactive mediums 3018 (e.g., “portals”) and one or more first interactive mediums 3018 or 3022A-D (e.g., “keys”), which may direct a user to a digital platform 3026 for access or decryptable access to information, the digital platform may be comprised of an input for the key and an output for information. In examples, such input may include input 3030 for the key 3006 and an output for information 3032, wherein once the key 3006 has been input, the information that is output is decrypted. In examples, digital platform 3026 may include a viewport to monitor the inputting of the one or more keys and an output for information 3032, where once the one or more keys have been input, the information that is output is decrypted and may be displayed via output 3032.

In examples, token 3000 may correspond to one or more links to websites or digital places or platforms in which the recipient or user may be directed. In embodiments, a user receiving the token 3000 may scan second scannable media 3018 (e.g., an NFC chip), which may forward the user to follow a link to a website or digital place. In examples, scanning the first scannable media 3006 (e.g., an associated QR code) may enable description of the associated information and allow view or otherwise access to the associated information. In embodiments, one or more key codes 3022A-D may be provided or viewable to the user as part of the token 3000. For example, a single code or code string 3022A-D may be written or coupled on token 3000. When a user scans the second scannable medium 3018, and is prompted and scans the first scannable medium 3006, the user may be directed to a programmable keyed portal 3026, and view now decrypted information associated with token 3000. In other examples, the user may scan second scannable medium 3018, which may bring the user to programmable digital portal 3026 and may input one or more key codes 3022A-D into the digital interface 3034, in which case the user may be directed to one or more websites, social media, videos, photos, etc. for user, interaction, updating, etc. as described herein.

In examples, a digital interface for code string input may be a programmable keyed portal 3026, much like a floor level input interface of an elevator, with a plurality of input capabilities (e.g., buttons). In examples, the key or key string input may be extended from 1 to n digits, letters, etc. associated with 1 to n input capabilities among interface 3034, which may be integrated into the programmable keyed portal 3026 and direct the user to a website or alternative digital information. Symbols outside digits 0, 1, 2, . . . 9 may be any string of symbols from the keys available on the programmable keyed portal 3026 as a string of any symbols, such as A, B, C, AA, BB, CC, etc. In examples, the programmable keyed portal 3026 may include a variety of other possible inputs such as a directory input 3052 which may be selected and may direct the user to a directory of key codes or strings each associated with a particular website or virtual place. In embodiments, the directory may be pre-populated with a plurality of key codes or strings. Additionally, the directory input among digital key portal 3036 may be configured to call an open channel line, wherein the open channel line is accessible to all who have access to additional or alternative tokens 3000/first scannable mediums 3006, associated with alternative encrypted content for view by the user.

As an additional or alternative, exemplary processes of use, token 3000 or alternative physical article may comprise one or more key codes 3022A-D, such as a code DDD (e.g., 3022D). following scanning of second scannable medium, a user may be prompted to enter or scan one or more first scannable mediums 3006 or keys 3022A-D. For example, when the code DDD is input into a programmable keyed portal 3026, via input interface (e.g., “elevator” interface) 3034 may trigger an event, forwarding access, or display of information via 3030 or 3034. In examples, an event of the present disclosure may comprise of opening another interface or viewport, playing a song, playing a video, or displaying information in one of the display areas 3030 or 3032.

It should be understood that the related applications relied on herein are incorporated in their entirety, and redundant repetition to access and process of the digital portal/“elevator” is avoided herein for simplicity.

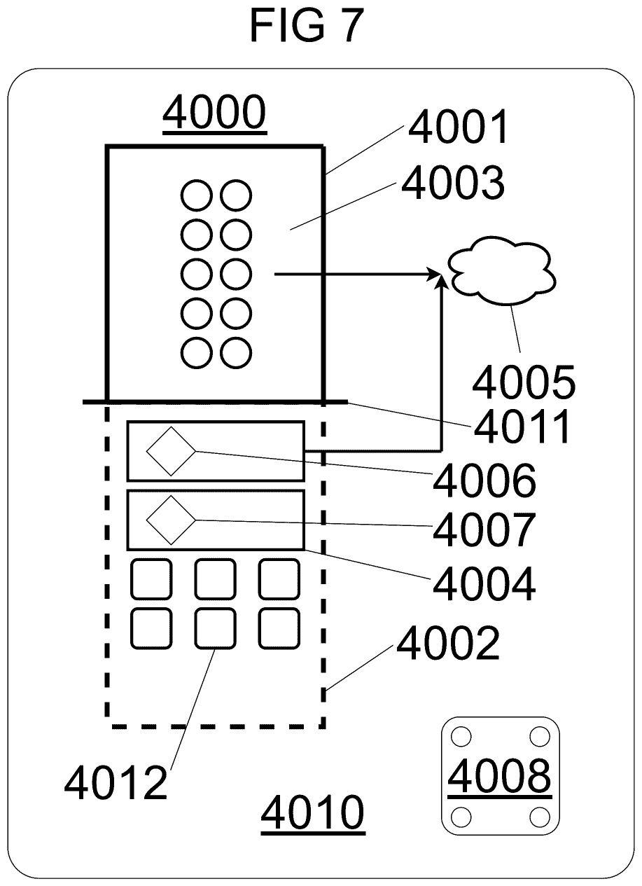

FIG. 7 is an illustrative diagram of facilitating access to information, such as encrypted information to be decrypted or non-encrypted information via a platform through a programmable key portal system, according to examples. In embodiments, an example interface 4000 may be depicted to access encrypted or decrypted information via one or more portal and key links or communications as described herein with reference to a programmable key portal. Such interface may comprise a first portion 4001 and a second portion 4002, wherein first portion 4001 may include a programmable keyed portal 4003 and second portion may be comprised one or more links 4004. In embodiments, links may be selected or otherwise accessible to a user such that the one or more links 4004 may redirect, at least a portion of interface 4000, to an alternative view, such as a website, photo, social media account, web-based store, etc. associated with each one or more links 4004. In embodiments, the programmable keyed portal 4003 may be programmed with one or more codes, wherein when a user enters the code into the programmable keyed portal 4003, the programmable keyed portal 4000 may return an output 4005. The link 4004 when clicked or otherwise selected also returns output 4005.

In examples, one or more links 4004 may express graphics of an album cover, photos, videos, and other media. In examples, one or more codes to the programmable keyed portal 4003 may initiate or play a song 4005 on the album, accessible and associated with the corresponding one or more links 4004 selected by the user. By clicking one or more links 4004 that express, for example, the album cover may also play the song 4005. In an example, playing the song may be defined as playing it from a local device or launching a player and streaming the song.

In examples, interface 4000 may provide one or more users with at least two or more means to arrive at a destination 4005. For example, a mean may be accessible through one or more programmable keyed portals 4003, or selectable elements among second position 4002 (e.g., applications, such as a social media application, stream-able media application, or the like). In examples, interface 4000 may provide one or more users with the means to sell or otherwise transfer art, graphics, displays, photos, videos, or the like between a first position 4006 and, at least, a second position 4007. In examples, a system 4010 for facilitating access to information, such as encrypted information to be decrypted or non-encrypted information via a platform may include interface 4000 and an article 4008 that connects a user to interface 4000, which may enable or otherwise facilitate access to the associated information, data, media, photos, and the like, for example, music 4005.

It should be noted that while first and second portions are described herein, additional portions may be included and viewable by a user. In examples, the interface may be swipe-able between two or more portions, such as first portions 4006 and second position 4007. Such adjustments may enable the interface 400 to include multiple access to various information, media, displays, photos, videos, etc. simultaneously. In examples, the user may swipe between portions such that the user may view or interact with a preferred portion. For example, a user may swipe or scroll down (or up) to a portion of the interface 4000 that controls a media output, such as music 4005, and may change the music, song, settings or the like. Once satisfied, the user may scroll or swipe back to a previous portion, for example, to view the new changed media of a photo album displayed in an alternative portion.

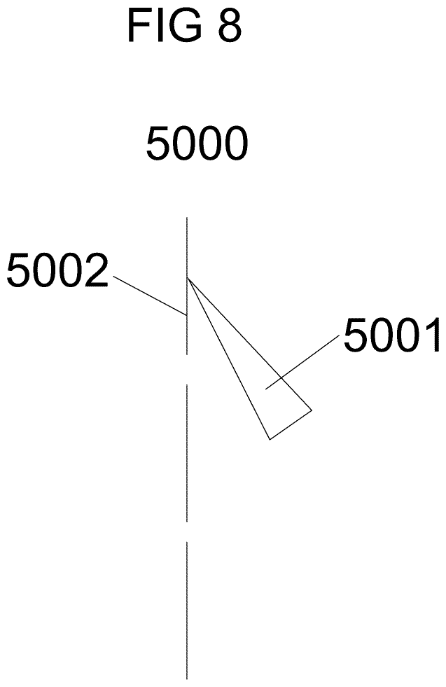

FIG. 8 is an illustrative diagram of an interface for haptic feedback during use, according to examples. In examples, an interface 5000, as described herein, may comprise a tactile interface further comprising of a stylus 5001 and one or more selectable features 5002. In examples, features 5002 may include clickable or otherwise selectable features, such as those similarly described with reference to FIG. 40. For example, one or more codes enterable into the programmable keyed portal 5003, one or more links 5004, selectable elements among second position 5002, etc. In examples, stylus 5001 may at least include one of a finger, a writing instrument, a pointed rod, an instrument which may include one or more electronic components.

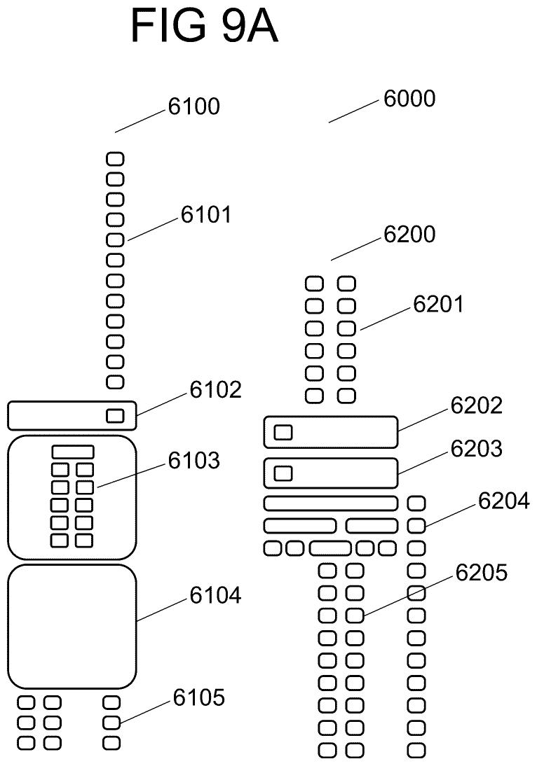

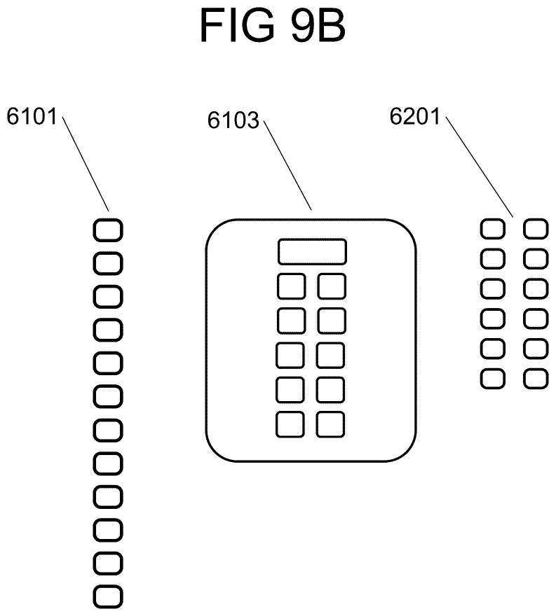

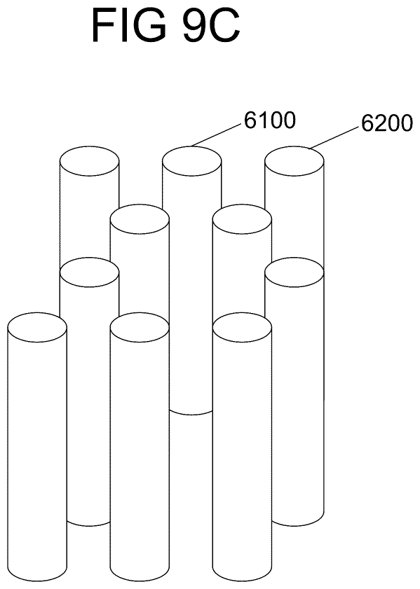

FIG. 9A is an illustrative example of a metaverse with multiplexing interfaces 6000 of the present invention. The metaverse with multiplexing interfaces 6000 comprises a first tower 6100 and a second tower 6200 where the first tower 6100 comprises multiplexing interfaces 6101 through 6105 and the second tower comprises multiplexing interfaces 6201 through 6205. Where by standard convention a multiplexer typically comprises first, a multiplexer that processes inputs into a multiplexed signal and second, a demultiplexer that processes a multiplexed signal into outputs, the metaverse with multiplexing interfaces of the present invention is comprises multiplexers and demultiplexers, processing inputs and outputs, respectively.

In one interpretation of FIG. 9A, a multiplexing interface 6100 accepts one or more codes via a programmable keyed portal 6101, processes the code, transmits a signal to another multiplexing interface 6200 that returns an enhanced signal that carries content that is displayed with multiplexing interface 6100 in content viewer 6104. In another interpretation, a multiplexing interface 6100 accepts one or more codes via a programmable keyed portal 6101, processes the code, transmits a signal to another multiplexing interface 6200 that returns an enhanced signal that carries content that is, referencing the before mentioned standard convention regarding multiplexers, demultiplexed by multiplexing interface 6100 providing an output via content viewer 6104.

In one interpretation of FIG. 9A, a multiplexing interface 6100 accepts one or more codes and triggers the initiation of a content capture mechanism such as a camera. The multiplexing interface 6100 then displays the content as it is being captured in the content viewer 6104 for live monitoring and further transmits or broadcasts the content to a second multiplexing interface 6200 that displays the content in one or more areas or portions configured for viewing content.

In one interpretation of FIG. 9A, two metaverses 6100 and 6200 of the present invention, each comprising one or more spatial or temporal dimensions or locations, comprise programmable keyed portals 6101, 6103, and 6201 whereby one or more users are provided the ability to enter a code and be transported to one, more, or multiple of another place, time, spatial location, or temporal location.

In one interpretation of FIG. 9A, a programmable keyed portal 6101 resembling the floor selection module of an elevator is presented as an antenna atop a tower. Optionally, a programmable keyed portal of the present invention is a series of books in a collection or a series of piano keys where when a user plays one or more notes in one example in the right order and with the right tempo, the user satisfies the gate requirement(s).

Optionally, a programmable keyed portal comprises anything that may be series or selected. A rotary phone or standard alphanumeric or alphabet or numeric keypad are some such examples.

In one interpretation of FIG. 9B, programmable keyed portals 6101, 6103, and 6201 that resemble the floor selection modules of elevators are presented. In another interpretation, multiplexing interfaces 6101, 6103, and 6201 that resemble the floor selection modules of elevators are presented.

In one interpretation of FIG. 9C, multiplexing interfaces 6100 and 6200 are arranged with other multiplexing interfaces, or towers, in a demonstrably three dimensional metaverse.

In one interpretation of FIG. 10A, metaverses with multiplexing interfaces 7100 and 7200, connectivity 7300 therebetween, programmable keyed portals 7101, 7201, floors 7120 and 7220, tags or tokens 7102, 7202, provide users 7111, 7112, 7211, 7212, with personalized user experiences.

In one interpretation of FIG. 10B, connections 7300 representing communication or signal pathways between metaverses with multiplexing interfaces 7100 and 7200 comprise third party services such as one or more virtual meeting services such as Google Meet®, WhatsApp®, Zoom®, Clubhouse®, or the like.

In one interpretation as illustrated in FIG. 70B, connections 7300 representing communication or signal pathways between metaverses with multiplexing interfaces 7100 and 7200 comprise third party services such as one or more virtual meeting services such as for example Google Meet® 7311 and 7312, WhatsApp® 7321 and 7322, Zoom® 7331, and Clubhouse® 7332, or the like. In one embodiment a communication connection or signal transportation connection is accessible via interface 7100 is accessible on one end 7311 and on another end 7312 via another interface 7200. A separate communication connection or signal transportation connection may simultaneously be available via interface 7100 is accessible on one end 7331 and on another end 7332 via another interface 7200. A first communication connection or signal transportation connection may simultaneously be available via interface 7100 and accessible on one end 7321 and a second communication connection or signal transportation connection available on another end 7322 via another interface 7200 with a communication translation module 7323 therebetween.

One or both of a spatially or temporally collapsable or expandable metaverse with an interface comprising multiplexing and merchandising systems affords a person, for example a musician, to quickly and inexpensively build a metaverse in the image of him, her, or their self or brand that easily spans two dimensional or three dimensional interfaces such as a phone or VR headset and that can connect one or more of people and content across any of the commercially available channels available today or that may be offered in the future.

2D towers of the metaverse are easily expanded to 3D using AI as a means by which to style a 3D tower with 2D content, or alternatively 3D towers are easily collapsed to 2D using a similar means. Typically if one were to build a 3D metaverse, they would need to 3D model a virtual environment which is generally time consuming. The present invention provides a person or builder to post content to a floor of a tower coded and accessible with a virtual elevator presented as an antenna of elevator buttons or as a typical elevator floor selection panel. The style of the posted content can then be ascertained by an AI and 2D building or tower can be expanded to 3D in a style that is consistent with the 2D building built by being populated with content by the builder or an AI on behalf of the builder. This method makes building a metaverse easy, inexpensive, and scalable.

The present invention allows the connection of one or more people and content across any of the commercially available channels available today or that may be offered in the future. Each floor of the tower within the metaverse is able to represent an endpoint of a communication or one or more of a content discovery, delivery, or access channel. Each floor can be programmed with a simple one or more of coded, low-code, or no-code interface to provide its communication or content related function by specifying and providing the credentials or means of access for a 3rd party system such as WhatsApp, a phone service, Clubhouse group, YouTube channel, or the like.

A programmable keyed portal in combination with merchandise articles, such as those described in the Figures, provides a multiplexing interface whereby a person or many people can access and utilize channel endpoints and connections therebetween. For example a person can pick up a merchandise item such as a tag or token, scan a provided link, access an elevator panel, input a first code provided by the tag or token into the elevator, access a WhatsApp group, and begin communicating with people in the WhatsApp group, or input a second code provided by the tag or token to access a YouTube video, or input a third code provided by the tag or token to go live via a broadcast system such as OwnSocial Live™.

Thus the invention described herein provides anyone with a turnkey solution to quickly and easy build a metaverse that spans any number of device dimensions, incorporate the functionality of any number of 3rd party systems or services, and do so in a fundamentally decentralized way that further establishes a decentralized social network and propagates the decentralization of social networking and other important systems for the benefit of everyone.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

1. A method of encrypting into a file one or more of data, images, sounds, videos, or other information where the encrypted information is viewable as one or more of data, images, sounds, videos, or other information for providing a metaverse in which a first user can provide a second user with content that is one or more of selectively discoverable, encrypted, or decrypted; the method comprising;
serializing an image to its RGB values from left to right and top to bottom;
adding the value to the product of the ordinal position and a large prime number, said prime number is selected by the value of a digit in a key to produce a large, pseudo-random number; the resulting large number is brought back into the 0-255 range using the modulo operator;
storing the pseudo random results in an array then combined into an image file of the same dimension as the original;
storing the encrypted image on a memory stick, a server or the cloud
restoring the pixel data from the encrypted image with the key by subtraction and modulo operators; the restored pixel data is constituted into an image of the same dimensions as the encrypted file and is identical to the original source image because the algorithm is deterministic.
utilizing an asymmetric public/private encryption (PGP) to eliminate the need to share a single key between the sender and receiver; and
provides the encryption/decryption operation within or between one or more metaverses as or with one or more multiplexing interfaces.

2. A method for generating a social network system includes;
connecting, by a user interface, a plurality of available websites each with at least one unique URL and at least one associated unique programmed key;
creating a set of tags, wherein each tag in the set of tags includes a QR code and a personalization area, such that the QR code directs a user to the user interface and the personalization area includes at least one unique programmed key;
providing a tag among the set of tags with the QR code and at least one unique programmed key to a user; and
scanning the QR code, by the user, with a user device; subsequent to scanning the QR code, presenting to a user device, the user interface configured to enable selection of one of the plurality of available websites based on a programmed key associated with the one of the plurality of available websites.

3. The method for generating a social network system of claim 2 wherein each tag includes an area for a programmed key and an area for an autograph, with a QR code linked to a programmable keyed portal.

4. A method for creating a personalized user experience, the method including;
accessing an online database of a plurality of available websites each with a unique URL, creating a set of tokens or tags, wherein each token or tag in the set of tokens or tags includes an area for a programmed key and an area for an autograph, and a QR code linked to a programmable keyed portal where each programmed key of the programmable keyed portal is associated with one of the plurality of available websites,
presenting to a user device, a user interface configured to enable selection, via entry of the programmed key, of one of the plurality of available websites via the user interface.

5. A method for encrypting into a file one or more of data, images, sounds, videos, or other information where the encrypted information is viewable as one or more of data, images, sounds, videos, or other information, the method comprising;
providing a metaverse and accessible via a multiplexing interface or component of a multiplexing interface such as a programmable keyed portal in the form of an illustrative elevator floor selection panel, wherein the multiplexing interfaces comprise a first tower and a second tower;
providing a multiplexer that processes inputs into a multiplexed signal and a demultiplexer that processes a multiplexed signal into outputs, wherein the multiplexing interface accepts one or more codes via a programmable keyed portal;
processing the code;
transmitting a signal to another multiplexing interface that returns an enhanced signal that carries content; and
displaying said content with multiplexing interface in a content viewer.
